(19) United States
(12) Patent Application Publication
(10) Pub. No.: US 2026/0091871 A1
(43) Pub. Date: Apr. 2, 2026

(54) PARTITION WALL FOR AN AIRCRAFT CABIN

(71) Applicant: Airbus Operations GmbH, HAMBURG (DE)

(72) Inventors: Christian WESSELINK, HAMBURG (DE); Paul-Niklas ECKE, HAMBURG (DE)

(21) Appl. No.: 19/341,234

(22) Filed: Sep. 26, 2025

(30) Foreign Application Priority Data
Sep. 27, 2024 (DE) 102024128049.2

(51) Int. Cl. B64D 11/00

(52) U.S. Cl. CPC B64D 11/0023

(57) ABSTRACT

A partition wall for dividing an aircraft cabin into individual sections, having at least one opaque air passage for enabling a pressure reduction between the sections through the partition wall. The wall also includes a frame and at least one stress-free planar element which is inserted into the frame. The at least one air passage is formed by a structure, a suspension in the frame, or both.

### CROSS-REFERENCE TO RELATED APPLICATIONS

This application claims priority to German Patent Application No. 10 2024 128 049.2, filed on Sep. 27, 2024, the entire disclosure of which is incorporated herein by way of reference.

### FIELD OF THE INVENTION

The invention relates to a partition wall for an aircraft cabin.

### BACKGROUND OF THE INVENTION

In aircraft cabins, partition walls are regularly installed to divide the aircraft cabin into sections, for example into 1st class and 2nd class. They are often erected in a sandwich construction and are relatively heavy.

Owing to certification-relevant specifications, the partition walls must withstand certain scenarios. For example, in the event of a rapid drop in pressure in the aircraft cabin, as defined in the Regulations CS-25, PAR 25.365, the partition walls must not lose their stability. Owing to the large areas of each partition wall, they must be mechanically reinforced accordingly, which leads to a weight increase in conventional partition walls. The weight increase not only leads to increased fuel consumption, but can in turn lead to further, weight-increasing reinforcing measures.

Partition walls characterized by a reduced weight are disclosed in the German Patent DE 10 2009 010 861 B4 of the applicant. This document discloses, inter alia, partition walls of modular design having a frame and a planar element stretched in the frame, such as a cloth or a sheet. The planar element can be stretched over the entire frame, or only over a frame region and a fixed panel-like planar element, for example made of CFRP, can be used in the remaining frame region.

An object of the invention is to provide an alternative partition wall for an aircraft cabin that meets the certification-relevant requirements.

### SUMMARY OF THE INVENTION

This object may be achieved with a partition wall having the features of one or more embodiments described herein.

A partition wall according to the invention for dividing an aircraft cabin into individual sections has at least one opaque or virtually opaque air passage for enabling a pressure reduction between the sections through the partition wall. According to the invention, the partition wall has a frame and at least one stress-free planar element which is inserted into the frame and whose structure/design/composition forms the at least one air passage and/or whose type of suspension in the frame forms the at least one air passage.

According to the invention, the at least one planar element forms quasi-intrinsically (structure/design/composition) the at least one air passage and/or through its type of retention in the frame, so that, in the latter, the planar element itself can be air-impermeable. Owing to the at least one air passage, the partition wall represents a reduced structural resistance in the case of pressure reduction, as a result of which it can be configured to be lighter compared with conventional partition walls, which has a positive effect on the fuel consumption of the aircraft due to the lower weight. On the one hand, the opacity prevents passengers from being able to look through the planar insert from one section into the other section. The restricted light-permeable design thus maintains privacy and spatial separation between the individual cabin classes. Since the at least one planar element is stress-free, no loads are introduced into the planar element under normal conditions. Preferably, not only the at least one planar element is stress-free, but also the type of suspension in the frame in order to reduce necessary holding forces of the frame.

In one exemplary embodiment, the at least one planar element is formed from at least two layers each having a plurality of air passages. The layers, preferably extending parallel, are here arranged with respect to one another in such a way that their air passages are arranged offset to one another. The air passages allow a continuous reduction of pressure. Since the air passages of the layers are arranged offset to one another, light beams cannot directly penetrate the planar element or can do so only to a limited degree, which ensures the greatest possible opacity. In addition, light beams passing through the air passages of one layer can impinge the other layer on the rear side and are reflected or scattered. Thus, the at least one planar element cannot be peered through. In addition, the layers on the sides facing them can be provided with a light-absorbing color. An example of such layers are perforated plates.

In one exemplary embodiment, the at least one planar element is formed from a plurality of partially overlapping lamellae. The lamellae can be arranged with respect to one another in a single row (one layer) or in a plurality of rows (a plurality of layers). If the lamellae are arranged in a single row, in each case the adjacent lamellae overlap, similar to a Venetian blind. If the lamellae are arranged in a plurality of rows, the adjacent lamellae of one layer can be spaced apart from one another, but the mutually opposite lamellae each form overlaps.

In one exemplary embodiment, the lamellae have a V-shaped cross section. The lamellae are here preferably nested in one another in the same orientation so that in a single-row arrangement a two-sided overlap (namely of their legs) is achieved.

In a further exemplary embodiment, the at least one planar element is formed as a pore element having a plurality of open pores as air passages. The pores are arranged here in such a way that light beams entering the pores are scattered in the pores. Light cannot pass through the planar element on “straight” paths nor can the planar element thus be peered through. The pores allow air compensation and thus a pressure reduction, with the opacity being achieved by their offset arrangement to one another.

An alternative exemplary embodiment of the at least one planar element provides a panel element which is held in such a way that the air can flow around its edge at least in one portion. Such a planar element may in particular have an air-impermeable design, since the pressure reduction takes place outside the planar element. For example, the edge may be surrounded by a U-shaped holder and the planar element may be held via rod-like supports in the holder.

Preferably, the at least one planar element is elastic. On the one hand, the pressure reduction is supported by this measure. The elasticity is such that under the conditions required by regulations, no destruction of the at least one planar element takes place, this also not being torn from its anchoring in the frame in the case of a maximum required rapid pressure reduction.

In order to achieve light effects on one side or else on both sides of the partition wall, a light insert can be inserted into the at least one planar element.

In one exemplary embodiment, at least the frame of the partition wall is produced in a modular manner or in differential construction. For example, aluminum, titanium and/or fiber composite components are releasably connected to one another. Such a differential construction enables disassembly and high recyclability of the individual components. Preferably, the partition wall consists of a material or of materials with a low CO₂ footprint, which are also recyclable. Thus, the partition wall according to the invention has a high environmental compatibility in comparison to the prior art.

These and other aspects and embodiments of the present invention, any of which may be combined in any manner with any other aspect, embodiment or configuration, will be appreciated by those of ordinary skill in the art based upon the following description of the drawings and detailed description.

### BRIEF DESCRIPTION OF THE DRAWINGS

In the following, preferred exemplary embodiments of the invention are explained in more detail using highly simplified schematic illustrations. Indications such as longitudinal direction x, transverse direction y and vertical direction z refer to the longitudinal direction, transverse direction and vertical direction of an aircraft cabin or of an aircraft. In the drawings:

FIG. 1a shows a plan view in the longitudinal direction x from rear to front in an aircraft cabin of one exemplary embodiment of a partition wall according to the invention;

FIG. 1b shows a side view in the transverse direction y of the aircraft cabin from the inside to the outside of the embodiment shown in FIG. 1a;

FIG. 1c shows a plan view in the longitudinal direction x from front to rear in the aircraft cabin of the embodiment shown in FIG. 1a;

FIG. 2 shows a frame of the partition wall according to the invention in differential construction;

FIG. 3a shows a filleting of interior corners or interspace corners of the frame;

FIG. 3b shows a corner insert for filleting;

FIG. 4a shows a first embodiment of planar elements of the partition wall according to the invention;

FIG. 4b shows a second embodiment of planar elements of the partition wall according to the invention;

FIG. 4c shows a third embodiment of planar elements of the partition wall according to the invention; and,

FIG. 4d shows a fourth embodiment of planar elements of the partition wall according to the invention.

### DETAILED DESCRIPTION OF THE PREFERRED EMBODIMENTS

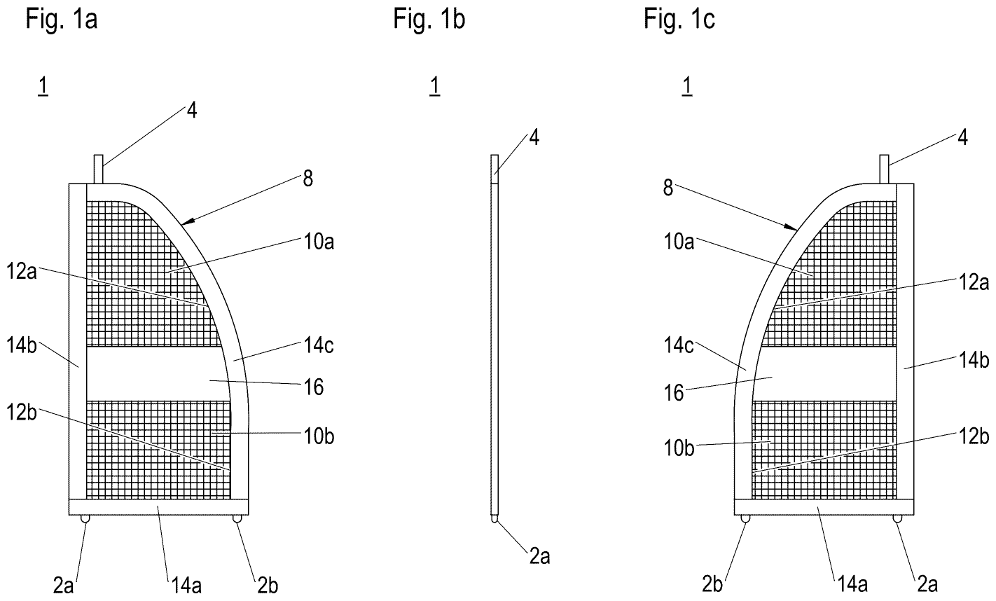

In FIGS. 1a, 1b and 1c there is shown a first exemplary embodiment of a partition wall 1 according to the invention. The partition wall 1 is used for the one-sided division of an aircraft cabin into a plurality of sections, for example into 1st class and into 2nd class.

FIG. 1a shows a plan view in the longitudinal direction x from rear to front in the aircraft cabin. FIG. 1b shows a side view in the transverse direction y of the aircraft cabin from the inside to the outside, and FIG. 1c shows a plan view in the longitudinal direction x from front to rear in the aircraft cabin.

The partition wall shown here is arranged on the right in the aircraft cabin and fixed to a rear structure of the aircraft cabin via lower fastenings 2a, 2b in floor rails and via at least one upper fastening 4.

The partition wall 1 has a frame 8 for stabilization and here two stress-free planar elements 10a, 10b which are inserted in each case into an interspace or a receiving opening 12a, 12b of the frame 8.

The partition wall 1 is produced in a differential construction from a plurality of individual components, which facilitates usability and also enables reusability. For example, the frame 8 is composed in a modular manner of a plurality of frame profiles 14a, 14b, 14c which delimit a frame interior in the transverse direction y and in the vertical direction z. It forms a frame which can be disassembled into its frame profiles 14a, 14b, 14c.

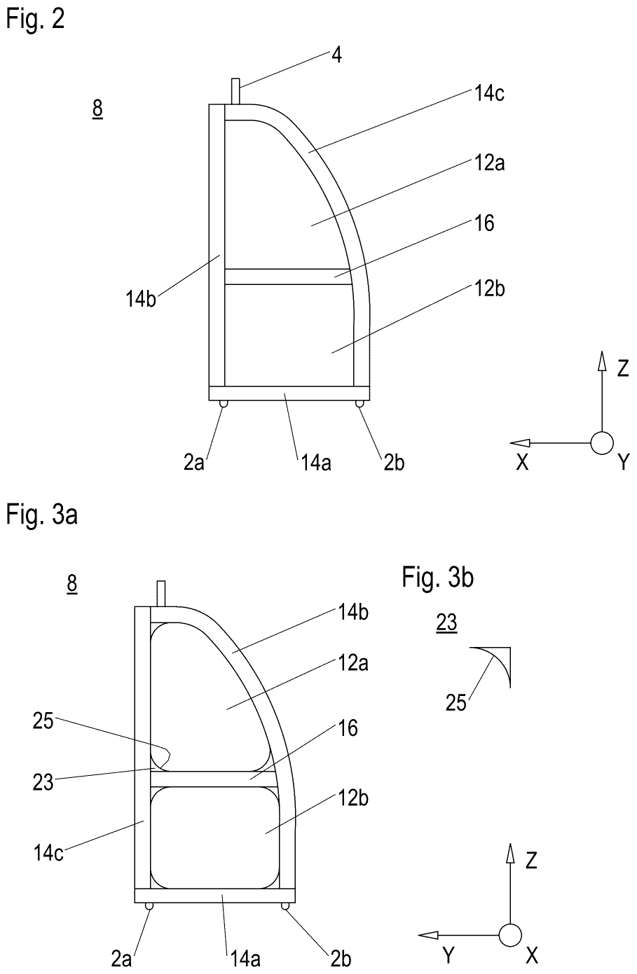

In the frame 8 there is inserted a passenger panel 16 which extends in the transverse direction between the two lateral frame profiles 14a, 14b. The passenger panel 16 is provided, for example, for the arrangement of monitors, trays and the like and is located at the eye-level region of a passenger sitting directly in front of the partition wall 1 in one section. It divides the frame interior into the upper interspace 12a and into the lower interspace 12b. As illustrated in FIG. 2, the passenger panel 16 may have different heights.

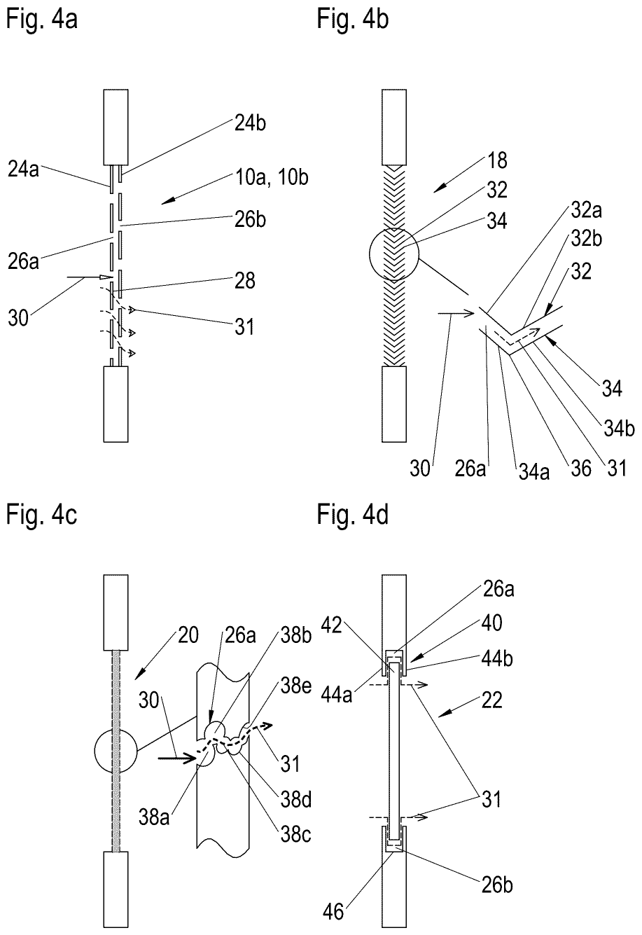

As shown in FIGS. 1a and 1c, in each case one of the planar elements 10a, 10b is inserted into the interspaces 12a, 12b over the whole area. In the exemplary embodiment shown here, the planar elements 10a, 10b are air-permeable, but opaque or as far as possible opaque. Each planar element 10a, 10b enables an air exchange and thus a rapid pressure reduction between the sections. Preferably, the planar elements 10a, 10b extend over the entire frame interior, minus a passenger panel surface. If no passenger panel 16 is installed, only a planar element 10a or 10b can be provided that then alone fills the entire frame interior. A detailed description of these planar elements 10a, 10b and the explanation of further stress-free planar elements 18, 20, 22 is given in FIGS. 4a to 4d. The type of suspension of the planar elements 10a, 10b, 18, 20, 22 in the respective frame 8 is preferably also stress-free.

As illustrated in FIG. 3a, corner inserts 23 shown in FIG. 3b can be used for filleting corners of the frame interior or the interspaces 12a, 12b, which corner inserts have a fillet 25 pointing into the respective interspace 12a, 12b.

As illustrated in FIG. 4a, the planar elements 10a, 10b have a design or a structure with in each case two layers 24a, 24b spaced apart from one another in the longitudinal direction x of the aircraft. There is air between the layers 24a, 24b. The layers 24a, 24b each have a plurality of openings as individual air passages 26a, 26b, through which in each case an air exchange or pressure reduction (dashed arrows 31) can take place. Exemplary layers 24a, 24b are perforated plates. The layers 24a, 24b are arranged with respect to one another in such a way that the air passages 26a, 26b are arranged offset to one another, i.e., in such a way that light beams 30 cannot pass through the planar elements 10a, 10bn directly, but after passing through the air passages 26a of one layer 24a impinge on the inner side 28 of the other layer 24b between their air passages 26b.

Of course, more than two layers 24a, 24b can also be provided.

In FIG. 4b, an air-permeable and opaque planar element 18 with a different type of design is shown. This planar element 18 has a plurality of lamellae 32, 34. The lamellae 32, 34 have a V-shaped cross section with two legs 32a, 32b or 34a, 34b. They are, for example, nested (plugged) into one another in the vertical direction z of the aircraft cabin in such a way that their tips 36 lie over one another in a thus vertical plane and thereby the legs 32a, 34a or 32b, 34b of the adjacent lamellae 32, 34 overlap. In each case an air passage 26a is thus formed between the adjacent lamellae 32, 34, wherein, as a result of the two-sided overlap, light beams 30 cannot reach from one side of the partition wall 1 to the other side of the partition wall 1 (detailed illustration in FIG. 4b).

In the case of the air-permeable and opaque planar element 20 shown in FIG. 4c, this has a pore structure and is thus formed as a pore element having a plurality of pores 38a to 38e as air passages 26a (detailed illustration in FIG. 4c). The arrangement of the pores 38a to 38e is such that light beams 30 are scattered within the pores 38a to 38e and thus cannot reach the other side of the partition wall 1 directly.

In FIG. 4d there is shown a planar element 22 with a design or a structure that is itself air-impermeable and opaque which includes virtually opaque or as far as possible opaque. It has a plate-like shape and is held in a holder 40 (suspension) of the frame 8 in such a way that air can flow around its edge 42. Air passages 26a, 26b are thus created between the edge 42 of the planar element 22 and the holder 40. For this purpose, the holder 40 has a U-shaped profile with two parallel legs 44a, 44b and a connecting portion 46 connecting the legs 44a, 44b to one another. The planar element 22 is in each case spaced apart from the legs 44a, 44b and the connecting portion 46. The fixing of the planar element 22 in the holder 40 can occur via webs (not shown) and the like, which simultaneously act as spacers. The legs 44a, 44b are themselves light-impermeable, so that this planar element 22 is also opaque in the region of the holder 40.

All planar elements 10a, 10b, 18, 20, 22 are elastic such that they can yield elastically in the event of a pressure reduction. The elasticity can be both an inherent property of the planar elements 10a, 10b, 18, 20, 22 but also, or in addition, can be realized by elastic retention in the frame 8.

In particular, a light insert can be integrated in the air-permeable planar elements 10a, 10b, 18, 22 in order to achieve a particular light effect on one side or on both sides. In the light-impermeable planar element 22, such a light insert is to be positioned in the region of the holder 40. It should be mentioned that the air-permeable planar elements 10a, 10b, 18, 20, 22 can also be held in a holder 40 according to the planar element 22, so that air additionally flows around its respective edge and thus an outer edge-side additional air passage is formed.

What is disclosed is a partition wall for dividing an aircraft cabin into individual sections, having at least one opaque air passage for enabling a pressure reduction between the sections through the partition wall.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Partition wall
2a, b Lower fastenings
4 Upper fastenings
8 Frame (modular, multi-part)
10a, b Planar element
12a, b Receiving opening/interspace
14a, b, c Frame profile
16 Passenger panel
18 Planar element
20 Planar element
22 Planar element
23 Corner insert
24a, b Layer
25 Fillet
26a, b Air passage
28 Inner side
30 Light beam
32 Lamella
31 Air exchange
32a, 34b Leg
34 Lamella
24a, 34b Leg
36 Tip
38a to 38e Pores
40 Holder
42 Edge
44a, b Leg
46 Connecting portion
50 Stiffeners/internal structure
X Longitudinal direction of the aircraft cabin
Y Transverse direction of the aircraft cabin
Z Vertical direction of the aircraft cabin

Claimed is:

1. A partition wall for dividing an aircraft cabin into individual sections, the partition wall comprising:
at least one air passage configured to enable a pressure reduction between the individual sections through the partition wall, wherein the at least one air passage is opaque;
a frame; and
at least one stress-free planar element which is inserted into the frame,
wherein a structure, a suspension in the frame, or both of the at least one stress-free planar element comprises the at least one air passage.

2. The partition wall according to claim 1, wherein the at least one planar element comprises at least two layers each having a plurality of air passages which are arranged with respect to one another in such a way that the plurality of air passages of the layers are arranged offset to one another.

3. The partition wall according to claim 1, wherein the at least one planar element is formed from a plurality of partially overlapping lamellae.

4. The partition wall according to claim 3, wherein the lamellae have a V-shaped cross section.

5. The partition wall according to claim 1, wherein the at least one planar element comprises a plurality of open pores as air passages, and
wherein light beams entering the plurality of open pores are scattered in the plurality of open pores.

6. The partition wall according to claim 1, wherein the at least one planar element further comprises a peripheral edge which is arranged in a U-shaped holder such that air flows around at least one edge portion.

7. The partition wall according to claim 1, wherein a light insert is inserted into the at least one planar element.

8. The partition wall according to claim 1, wherein the frame is modular.
